(19) United States
(12) Patent Application Publication
(10) Pub. No.: US 2026/0084288 A1
(43) Pub. Date: Mar. 26, 2026

(54) TRANSPORT ROBOT AND METHOD OF CONTROLLING THE SAME

(71) Applicant: HL Robotics Co., Ltd., Seongnam-si (KR)

(72) Inventor: Kyuwon KIM, Seongnam-si (KR)

(73) Assignee: HL Robotics Co., Ltd., Seongnam-si (KR)

(21) Appl. No.: 19/341,144

(22) Filed: Sep. 26, 2025

(30) Foreign Application Priority Data
Sep. 26, 2024 (KR) 10-2024-0131102

(51) Int. Cl. B25J 9/00; B25J 9/16; B25J 11/00; B25J 19/02; G01S 17/894

(52) U.S. Cl. CPC B25J 9/0009; B25J 9/161; B25J 11/005; B25J 19/021; G01S 17/894

(57) ABSTRACT

The present disclosure may provide a transport robot and a method of controlling the same. The transport robot includes a drive device, a first lidar and a second lidar installed on the transport robot, and a processor. The processor controls the drive device to move the transport robot to a lower side of a target object and determines positioning information based on data from both lidars during movement. The processor identifies whether either lidar enters the lower side of the target object, and when one lidar is identified as entering the lower side, determines the positioning information based on data from the non-entering lidar.

### CROSS-REFERENCE TO RELATED APPLICATION

This application claims the priority of Korean Patent Application No. 10-2024-0131102 filed on Sep. 26, 2024, in the Korean Intellectual Property Office, the disclosure of which is incorporated herein by reference.

### BACKGROUND

### 1. Technical Field

The present disclosure relates to a transport robot and a method of controlling the same.

### 2. Related Art

As vehicles have become more prevalent and the number of vehicles has increased, parking spaces have become insufficient. In order to cope with the insufficient parking spaces, there is an increasing effort to utilize the parking spaces more efficiently.

However, with the practical constraint of space, even skilled drivers have difficulty in parking the vehicles in narrow parking spaces in parking lots. For this reason, collision accidents often occur in the parking lots. In order to solve the above-mentioned problem, an automatic transport robot is being developed, which enters a lower side of the vehicle, raises the vehicle partially, and automatically parks the vehicle.

In general, various sensor devices are installed in the automatic transport robot and assist in recognizing an accurate position of the robot to allow the robot to accurately enter the lower side of the target vehicle. Examples of the sensor devices include an inertia measurement unit (IMU), an encoder, a lidar, a camera, and the like.

The automatic transport robot performs robot positioning based on data acquired from the sensor devices such as the inertia measurement unit, the encoder, the lidar, and the like. However, in case that the automatic transport robot enters the lower side of the target vehicle, the reliability of the lidar deteriorates, which causes a problem in that positioning values are incorrect.

### SUMMARY

An object to be achieved by the present disclosure is to provide a transport robot, in which when a first lidar or a second lidar identifies that the transport robot enters a lower side of a target object while the transport robot moves toward the target object, the transport robot performs positioning based on lidar data of the remaining lidar while excluding lidar data of the corresponding lidar, such that the transport robot may accurately move to the lower side of the target vehicle based on reliable positioning information, and a method of controlling the same.

Another object to be achieved by the present disclosure is to provide a transport robot, in which when the remaining lidar also enters the lower side of the target object while the transport robot enters the lower side of the target object, and then the remaining lidar identifies that the transport robot completely enters the lower side of the target object, the transport robot performs positioning based on inertia data and odometry data while excluding lidar data, thereby acquiring more reliable positioning information, and a method of controlling the same.

One aspect of the disclosed disclosure provides a transport robot including: a drive device configured to move the transport robot; a first lidar installed on the transport robot and configured to acquire first lidar data directed in a first direction; a second lidar installed on the transport robot and configured to acquire second lidar data directed in a second direction; and a processor configured to control the drive device to move the transport robot to a lower side of a target object and determine positioning information of the transport robot based on the first lidar data and the second lidar data while the transport robot moves to the lower side of the target object, in which the processor identifies whether the first lidar or the second lidar enters the lower side of the target object based on the first lidar data and the second lidar data, and in which when the first lidar or the second lidar is identified as entering the lower side of the target object, the processor determines the positioning information based on lidar data of a lidar that is the first lidar or the second lidar that is not identified as entering the lower side of the target object.

The processor may merge point clouds of the first lidar data and the second lidar data and determine the positioning information by matching pre-stored map information and a feature point extracted from the merged point cloud, and when the first lidar or the second lidar is identified as entering the lower side of the target object, the processor may determine the positioning information by matching the pre-stored map information and the feature point extracted from the point cloud of the lidar data of the lidar that is the first lidar or the second lidar that is not identified as entering the lower side of the target object.

The processor may determine, based on the first lidar data, the first lidar as the lidar identified as entering the lower side of the target object when a ratio of a point cloud, which corresponds to the lower side of the target object, to the entire point cloud, which excludes a ground surface, is a predetermined critical value or more, and the processor may determine, based on the second lidar data, the second lidar as the lidar identified as entering the lower side of the target object when the ratio of the point cloud, which corresponds to the lower side of the target object, to the entire point cloud, which excludes the ground surface, is the predetermined critical value or more.

The processor may perform control to turn off the lidar that is the first lidar or the second lidar that is identified as entering the lower side of the target object.

The transport robot may further include: an inertia measurement unit installed on the transport robot and configured to acquire inertia data; and an encoder installed on the transport robot and configured to acquire odometry data, in which the processor identifies whether the transport robot completely enters the lower side of the target object based on the lidar data of the lidar that is the first lidar or the second lidar that is not identified as entering the lower side of the target object, and in which the processor determines the positioning information based on the inertia data and the odometry data when the transport robot is identified as completely entering the lower side of the target object.

The processor may determine the positioning information by performing dead reckoning based on the inertia data and the odometry data.

The processor may identify that the transport robot completely enters the lower side of the target object when a ratio of a point cloud, which corresponds to the lower side of the target object, to the entire point cloud, which excludes a ground surface, is a predetermined critical value or more based on the lidar data of the lidar that is the first lidar or the second lidar that is not identified as entering the lower side of the target object.

The processor may control the drive device so that the transport robot moves to a predesignated lower position of the target object based on the positioning information.

The processor may perform control to turn off the lidar that is the first lidar or the second lidar that is not identified as entering the lower side of the target object when the transport robot is identified as completely entering the lower side of the target object.

The predesignated lower position of the target object may be a position corresponding to any one of first and second positions of the target object.

Another aspect of the disclosed disclosure provides a method of controlling a transport robot including a drive device and a processor, the method including: controlling the drive device so that the transport robot moves to a lower side of a target object; determining positioning information of the transport robot based on first lidar data directed in a first direction and acquired by a first lidar and second lidar data directed in a second direction and acquired by a second lidar while the drive device is controlled; identifying whether the first lidar or the second lidar enters the lower side of the target object based on the first lidar data and the second lidar data; and determining the positioning information based on lidar data of a lidar that is the first lidar or the second lidar that is not identified as entering the lower side of the target object when the first lidar or the second lidar is identified as entering the lower side of the target object.

The determining of the positioning information of the transport robot based on the first lidar data and the second lidar data may include: merging point clouds of the first lidar data and the second lidar data; and determining the positioning information by matching pre-stored map information and a feature point extracted from the merged point cloud, and the determining of the positioning information based on the lidar data of the lidar that is not identified as entering the lower side of the target object may include determining the positioning information by matching the pre-stored map information and the feature point extracted from the point cloud of the lidar data of the lidar that is the first lidar or the second lidar that is not identified as entering the lower side of the target object.

The identifying of whether the first lidar or the second lidar enters the lower side of the target object may include: determining, based on the first lidar data, the first lidar as the lidar identified as entering the lower side of the target object when a ratio of a point cloud, which corresponds to the lower side of the target object, to the entire point cloud, which excludes a ground surface, is a predetermined critical value or more; and determining, based on the second lidar data, the second lidar as the lidar identified as entering the lower side of the target object when the ratio of the point cloud, which corresponds to the lower side of the target object, to the entire point cloud, which excludes the ground surface, is the predetermined critical value or more.

The method may further include: turning off the lidar that is the first lidar or the second lidar that is identified as entering the lower side of the target object.

The method may further include: identifying whether the transport robot completely enters the lower side of the target object based on the lidar data of the lidar that is the first lidar or the second lidar that is not identified as entering the lower side of the target object; and determining the positioning information based on inertia data acquired by an inertia measurement unit and odometry data acquired by an encoder when the transport robot is identified as completely entering the lower side of the target object.

The determining of the positioning information based on the inertia data and the odometry data may include determining the positioning information by performing dead reckoning based on the inertia data and the odometry data.

The identifying of whether the transport robot completely enters the lower side of the target object may include identifying that the transport robot completely enters the lower side of the target object when a ratio of a point cloud, which corresponds to the lower side of the target object, to the entire point cloud, which excludes a ground surface, is a predetermined critical value or more based on the lidar data of the lidar that is the first lidar or the second lidar that is not identified as entering the lower side of the target object.

The method may further include: controlling the drive device so that the transport robot moves to a predesignated lower position of the target object based on the positioning information.

The method may further include: turning off the lidar that is the first lidar or the second lidar that is not identified as entering the lower side of the target object when the transport robot is identified as entering the lower side of the target object.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIGS. 1 and 2 are views illustrating a first transport robot and a second transport robot according to an embodiment;

FIG. 3 is a block diagram illustrating configurations of the first and second transport robots according to the embodiment;

FIGS. 4A-4C are views for explaining operations of the first transport robot and/or the second transport robot according to the embodiment;

FIG. 5 is a flowchart illustrating an operation from a time point at which the first transport robot and/or the second transport robot according to the embodiment begin to move to a target object to a time point at which the first transport robot and/or the second transport robot are identified as entering a lower side of the target object;

FIG. 6 is a flowchart illustrating an operation of determining positioning information before the first transport robot and/or the second transport robot according to the embodiment are identified as entering the lower side of the target object;

FIG. 7 is a flowchart illustrating an operation of identifying whether a first lidar or a second lidar of the first transport robot and/or the second transport robot according to the embodiment enter the lower side of the target object;

FIG. 8 is a flowchart illustrating an operation of determining positioning information while the first transport robot and/or the second transport robot according to the embodiment move to a predesignated lower position of the target object from a time point at which the first transport robot and/or the second transport robot completely enter the lower side of the target object;

FIG. 9 is a flowchart illustrating an operation of identifying that the first transport robot and/or the second transport robot according to the embodiment completely enter the lower side of the target object; and

FIGS. 10A-10B are views exemplarily illustrating an ROI (region of interest) for identifying that the first transport robot and/or the second transport robot according to the embodiment enter the lower side of the target object.

### DETAILED DESCRIPTION OF EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals indicate like constituent elements throughout the specification. The present specification does not explain all the elements in the embodiments, and the general contents in the technical field to which the disclosed disclosure pertains or the contents repeatedly described in the embodiments will be omitted. The terms ‘part’, ‘module’, ‘member’, ‘block’ and the like as used in the specification may be implemented in software or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the present specification, when one constituent element is referred to as being “connected to” another constituent element, one constituent element can be “directly connected to” the other constituent element, and one constituent element can also be “indirectly connected to” the other constituent element. The indirect connection includes a connection through a wireless communication network.

In addition, unless explicitly described to the contrary, the word “comprise/include” and variations such as “comprises/includes” or “comprising/including” will be understood to imply the inclusion of stated elements, not the exclusion of any other elements.

Throughout the specification, when one member is disposed “on” another member, this includes not only a case where the one member is brought into contact with another member, but also a case where still another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

The disclosed disclosure is intended to provide a technology in which two transport robots, e.g., a leading transport robot and a trailing transport robot may enter a lower side of a target object and accurately move to a predesignated position at the lower side of the target object to cooperatively move the target object to a target position.

The transport robot needs to accurately move to the predesignated position at the lower side of the target object to raise the target object at the lower side of the target object. Autonomous driving is performed during the process in which the transport robots move. In this case, the leading transport robot and the trailing transport robot are required to be accurately positioned (localized) while the two transport robots move to the predesignated positions at the lower side of the target object.

In general, the transport robot acquires transport robot positioning information based on data acquired from sensor devices, such as an inertia measurement unit (IMU), a camera, an encoder, and a lidar, installed in the transport robot while the transport robot moves to the lower side of the target object.

The IMU may provide inertia data such as a rotation (yaw) of the transport robot, and the transport robot may correct a rotation direction or the like of the transport robot based on the rotation (yaw) of the transport robot. The encoder acquires odometry data by measuring a distance that the transport robot moves based on the number of rotations of a wheel. The transport robot performs the positioning based on the inertia data and the odometry data while the transport robot travels.

The lidar sensor creates, in real time, a 3D map of a surrounding environment and perform the transport robot positioning by comparing the 3D map with the previously stored map information (map matching).

The transport robot acquires final positioning information by applying the positioning information, which is acquired from the lidar sensor, to the positioning information previously acquired based on the inertia data and the odometry data. In this process, the transport robot may reduce noise by utilizing a Kalman filter and estimate a more accurate position, thereby acquiring highly reliable positioning information.

However, the environment recognized by the lidar is rapidly changed when the transport robot enters the lower side of the target object. Because a lower structure of a vehicle is complicated and narrow, unlike a general environment at ordinary times, the lidar cannot properly utilize the previously stored map information, which rapidly degrades the reliability.

The disclosed present disclosure is intended to provide a technology for improving positioning reliability by ensuring a wider visual field range by utilizing the first lidar and the second lidar in a situation in which the transport robot moves to the target object before entering the lower side of the target object.

The disclosed present disclosure is intended to provide a technology for improving positioning accuracy by identifying a situation in which the lidar decreases in reliability and cannot perform accurate positioning when the transport robot enters the lower side of the target object, as described above.

Hereinafter, operation principles and embodiments of the disclosed disclosure will be described in detail with reference to the accompanying drawings.

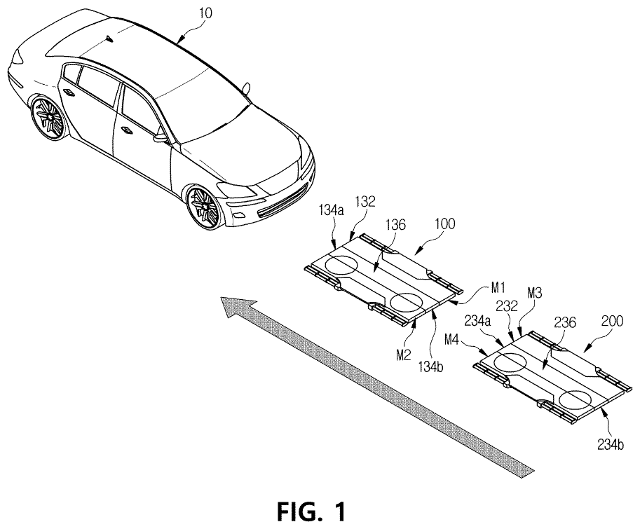

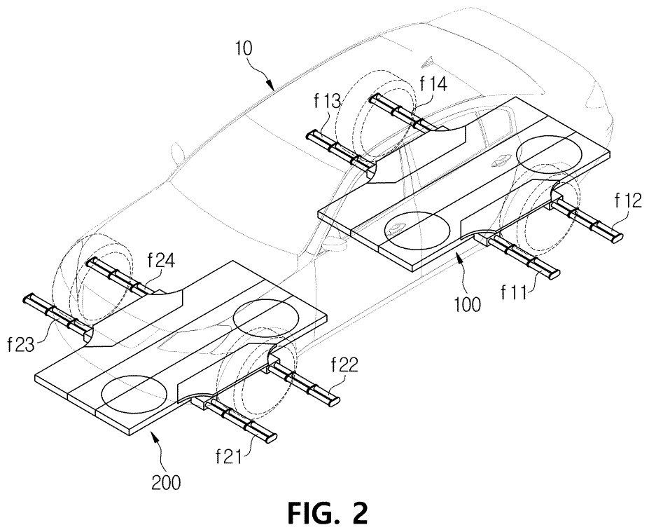

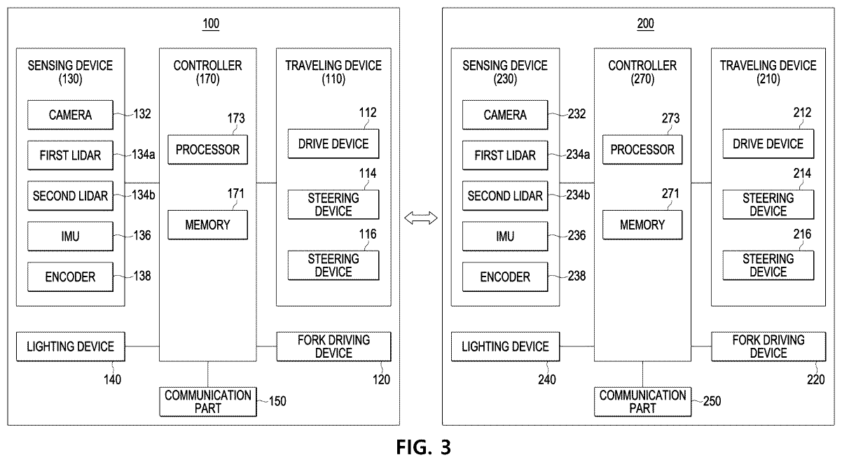

FIGS. 1 and 2 are views illustrating a first transport robot and a second transport robot according to an embodiment. FIG. 3 is a block diagram illustrating configurations of the first and second transport robots according to the embodiment.

In the present disclosure, the transport robot may be the first transport robot or the second transport robot. The transport robot is not limited to any one of the first transport robot or the second transport robot.

In the present disclosure, the target object is described as a vehicle, but the target object is not limited to the vehicle. The target object may be understood as an object (or a subject) that may be moved by the transport robot.

With reference to FIGS. 1 and 2, a first transport robot 100 and a second transport robot 200 may cooperate to park a target vehicle 10 in a parking zone.

For example, the first transport robot 100 and the second transport robot 200 may move to a lower side of the vehicle 10, i.e., enter a lower side of the target vehicle 10, raise the target vehicle 10, and then park the target vehicle 10 in the parking zone.

With reference to FIGS. 1 and 2, the first transport robot 100 may be a leading transport robot, and the second transport robot 200 may be a trailing transport robot that follows the first transport robot 100.

With reference to FIG. 3, the first transport robot 100 may include a traveling device 110, a fork driving device 120, a sensing device 130, a lighting device 140, a communication part 150, and/or a controller 170.

The traveling device 110, the fork driving device 120, the sensing device 130, the lighting device 140, and the communication part 150 are not essential components of the first transport robot 100, and at least some of the above-mentioned components may be excluded.

The traveling device 110 may move and stop the first transport robot 100 and/or change a movement direction of the first transport robot 100.

To this end, the traveling device 110 may include a drive device 112, a braking device 114, and/or a steering device 116.

The drive device 112 may move the first transport robot 100. For example, the drive device 112 may include a motor (or also referred to as an ‘electric motor’) and rotate a wheel (or also referred to as an ‘electric wheel’) of the first transport robot 100 by providing driving power to the motor to move the first transport robot 100.

For example, the wheel of the first transport robot 100 may be provided as a single wheel or a plurality of wheels and variously implemented in accordance with design.

The braking device 114 may stop a movement of the first transport robot 100. For example, the braking device 114 may include components such as a brake pad and a disc and stop the first transport robot 100.

The steering device 116 may change a movement direction of the first transport robot 100. For example, the steering device 116 may include components such as the motor or a hydraulic system for controlling a direction of the wheel of the first transport robot 100 and change the movement direction of the first transport robot 100.

The sensing device 130 may include one or more sensors capable of generating electrical signals or data corresponding to a state of the first transport robot 100 and/or an external state of the first transport robot 100.

The fork driving device 140 may include one or more motors or the like capable of providing driving power for motions of a plurality of forks f11, f12, f13, and f14 of the first transport robot 100.

With reference to FIG. 2, the first transport robot 100 may include the plurality of forks f11, f12, f13, and f14 having lengths extending from two opposite sides of a main body to support two opposite wheels at a rear side of the target vehicle 10.

For example, the forks f11, f12, f13, and f14 of the first transport robot 100 may each be implemented as a structure that may switch from a folded state to an unfolded state or switch from the unfolded state to the folded state on the basis that the fork driving device 140 is controlled by the controller 170.

In addition, the forks f11, f12, f13, and f14 of the first transport robot 100 may each be implemented as a structure that may ascend upward or descend downward in the unfolded state on the basis that the fork driving device 140 is controlled by the controller 170.

As another example, the forks f11, f12, f13, and f14 of the first transport robot 100 may each be implemented as a structure that may expand outward from the main body and change to a shape contracted toward the main body from the state expanding outward on the basis that the fork driving device 140 is controlled by the controller 170.

In addition, the forks f11, f12, f13, and f14 of the first transport robot 100 may each be implemented as a structure that may ascend upward or descend downward in the state expanding outward based on the main body on the basis that the fork driving device 140 is controlled by the controller 170.

The sensing device 130 may include a camera 132, a first lidar 134a, a second lidar 134b, an inertia measurement unit (IMU) 136, and/or an encoder 138.

The camera 132, the first lidar 134a, the second lidar 134b, the inertia measurement unit (IMU) 136, and/or the encoder 138 are not essential components of the sensing device 130, and at least some of the above-mentioned components may be excluded.

The camera 132 may acquire image data of the surrounding of the first transport robot 100. For example, the camera 132 may include a plurality of lenses (not illustrated), an image sensor, and/or an image processor (not illustrated).

The camera 132 may be provided as a single camera or a plurality of cameras and disposed on the main body of the first transport robot 100.

With reference to FIG. 1, the camera 132 may be disposed on the main body of the first transport robot 100 so as to have a visual field directed in a first direction (or also referred to as a ‘forward direction’) in which the first transport robot 100 moves.

With reference to FIG. 1, the first lidar 134a may be disposed on the main body of the first transport robot 100 so as to have a visual field in the first direction (or forward direction) in which the first transport robot 100 moves. The first lidar 134a may create first lidar data directed in the first direction (or forward direction).

The second lidar 134b may be disposed on the main body of the first transport robot 100 so as to have a visual field in a second direction (or also referred to as a ‘rearward direction’) that is a direction opposite to the first direction in which the first transport robot 100 moves. The second lidar 134b may create second lidar data directed in the second direction (or rearward direction).

The IMU 136 may acquire inertia data such as a velocity, a direction, and/or an acceleration of the first transport robot 100 and be disposed on the main body of the first transport robot 100.

With reference to FIG. 1, the IMU 136 may be disposed at a center of the main body of the first transport robot 100.

The encoder 138 may acquire odometry data such as a traveling distance of the first transport robot 100 and be disposed in or adjacent to the wheel of the first transport robot 100.

The encoder 138 may be provided as a single encoder or a plurality of encoders.

The lighting device 140 may include one or more light sources or light source arrays and be disposed on the main body of the first transport robot 100. For example, various lighting devices (e.g., a light-emitting diode (LED), a halogen lamp, and the like) in the related art may be applied to the lighting device 140.

With reference to FIG. 1, markers, e.g., a first marker M1 and a second marker M2 may be disposed on the first transport robot 100. Although not illustrated, the lighting device 140 may be disposed on lower surfaces of the first and second markers M1 and M2 or disposed on the main body of the first transport robot 100 adjacent to the lower surfaces of the first and second markers M1 and M2 so that the visual fields toward the first marker M1 and the second marker M2 may be ensured.

For example, the first marker M1 and the second marker M2 may be manufactured to include an identifiable predetermined pattern, e.g., a pattern having four corner points.

The communication part 150 may establish a wireless communication channel between the first transport robot 100 and the second transport robot 200 and support communication performed through the established communication channel. The communication part 150 may include a communication circuit, and/or a control circuit capable of controlling an operation of the communication circuit. The communication part 150 may include a cellular communication module, a Wi-Fi communication module, a near-field communication module (e.g., a Bluetooth communication module), and/or a global navigation satellite system (GNSS) communication module and communicate with the second transport robot 200 through any one module.

The controller 170 may be electrically connected to and/or communicate with the constituent elements, e.g., the traveling device 110, the fork driving device 120, the sensing device 130, the lighting device 140, and/or the communication part 150 of the first transport robot 100 and control the constituent elements.

For example, the controller 170 may process the data acquired by the sensing device 130 and process the data received from the external device, e.g., the second transport robot 200 through the communication part 150. In addition, based on a result of processing the data acquired by the sensing device 130 and/or a result of processing the data received through the communication part 150, the controller 170 may provide control signal to the corresponding constituent elements among the traveling device 110, the fork driving device 120, the sensing device 130, the lighting device 140, and/or the communication part 150.

The controller 170 may acquire positioning information about the first transport robot 100 based on the data acquired through the sensing device 130, e.g., the camera 132, the first lidar 134a, the second lidar 134b, the IMU 136, and/or the encoder 138.

The controller 170 may move the target vehicle 10 and park the target vehicle 10 in a designated parking zone through cooperative control with the second transport robot 200 through the communication part 150. In this case, the controller 170 may additionally utilize the data acquired through the sensing device 130.

Based on the data acquired through the sensing device 130 and/or the data communication with the second transport robot 200 through the communication part 150, the controller 170 may control the drive device 112 included in the traveling device 110 and allow the first transport robot 100 to move to the lower side of the target vehicle 10.

The controller 170 may control the fork driving device 120 through the cooperative control with the second transport robot 200 through the communication part 150 so that the plurality of forks f11, f12, f13, and f14 may support the two opposite wheels at the rear side of the target vehicle 10, and then the plurality of forks f11, f12, f13, and f14 may ascend upward. In this case, a plurality of forks f21, f22, f23, and f24 of the second transport robot 200 may support two opposite wheels at a front side of the target vehicle 10, and then the plurality of forks f21, f22, f23, and f24 may ascend upward.

In addition, in the state in which the plurality of forks f11, f12, f13, and f14 is raised upward, the controller 170 may move to the parking zone by controlling the drive device 112 included in the traveling device 110 while performing the cooperative control with the second transport robot 200 through the communication part 150. In this case, the second transport robot 200 may also move to the parking zone in the state in which the plurality of forks f21, f22, f23, and f24 is raised upward.

In addition, after the controller 170 moves to the parking zone, the controller 170 may perform control to lower the plurality of forks f11, f12, f13, and f14 and allow the plurality of forks f11, f12, f13, and f14 to release the two opposite wheels at the rear side by performing the cooperative control with the second transport robot 200 through the communication part 150. In this case, the second transport robot 200 may also lower the plurality of forks f21, f22, f23, and f24, and the plurality of forks f21, f22, f23, and f24 may release the two opposite wheels at the front side.

The controller 170 may include a memory 171 and/or a processor 173.

The memory 171 may store software programs for the first transport robot 100. The memory 171 may store programs and/or data for processing data (the data acquired through the sensing device 130 and/or the data received through the communication part 150).

The memory 171 may store a 3D map (or map information) of a parking lot (or parking location). The processor 173 may temporarily store the 3D map of a real-time surrounding environment created based on first and second lidar data acquired through the first and second lidars 134a and 134b.

The memory 171 may store identifiable predetermined patterns of markers of another transport robot including markers M3 and M4 of the second transport robot 200.

The memory 171 may be temporarily memorize the data and temporarily memorize a result of processing the data of the processor 173.

The memory 171 may include not only volatile memories such as an S-RAM or a D-RAM, but also non-volatile memories such as a flash memory, a read-only memory (ROM) or an erasable programmable read-only memory (EPROM).

The processor 173 may process the data and provide the corresponding device with signals for controlling the traveling device 110, the fork driving device 120, the sensing device 130, the lighting device 140, and/or the communication part 150. For example, the processor 173 may include a micro control unit (MCU).

The processor 173 may control the fork drive device 120 so that the first transport robot 100 moves to the lower side of the target vehicle 10.

The processor 173 may determine the positioning information of the first transport robot 100 based on the map information of the parking location stored in the memory 171 and the first and second lidar data acquired through the first and second lidars 134a and 134b while the first transport robot 100 moves to the lower side of the target vehicle 10.

Specifically, the processor 173 may determine the positioning information by merging point clouds of the first and second lidar data and matching a feature point, which is extracted from the merged point cloud and the map information of the parking location.

The processor 173 may identify whether the first lidar 134a or the second lidar 134b enters the lower side of the target vehicle 10 based on the first and second lidar data.

That is, the processor 173 may determine the first lidar 134a or the second lidar 134b as a lidar (or entry lidar) identified as entering the lower side of the target vehicle 10.

To this end, based on the first lidar data, the processor 173 may determine the first lidar 134a as the lidar (entry lidar) identified as entering the lower side of the target vehicle 10 when a ratio of a point cloud, which corresponds to the lower side of the target vehicle 10, to the entire point cloud, which excludes a ground surface, is a predetermined critical value or more. When the first lidar 134a is determined as the entry lidar, the processor 173 may determine the second lidar 134b as a lidar (or non-entry lidar) that is not identified as entering the lower side of the target vehicle 10.

Based on the second lidar data, the processor 173 may determine the second lidar 134b as the lidar (or entry lidar) identified as entering the lower side of the target vehicle 10 when the ratio of the point cloud, which corresponds to the lower side of the target vehicle 10, to the entire point cloud, which excludes the ground surface, is the predetermined critical value or more. When the second lidar 134b is determined as the entry lidar, the processor 173 may determine the first lidar 134a as a lidar (or non-entry lidar) that is not identified as entering the lower side of the target vehicle 10.

In this case, the processor 173 may perform control to turn off the lidar (entry lidar) that is the first lidar 134a or the second lidar 134b that is identified as entering the lower side of the target vehicle 10.

Regardless of which lidar is determined as the entry lidar, the processor 173 may determine the positioning information based on the map information of the parking location and the lidar data of the lidar (non-entry lidar) that is not identified as entering the lower side of the target vehicle 10.

Next, based on the lidar data of the lidar (non-entry lidar) that is the first lidar 134a or the second lidar 134b that is not identified as entering the lower side of the target vehicle 10, the processor 173 may identify whether the first transport robot 100 completely enters the lower side of the target vehicle 10.

Based on the lidar data of the lidar (non-entry lidar) that is the first lidar 134a or the second lidar 134b that is not identified as entering the lower side of the target vehicle 10, the processor 173 may identify that the first transport robot 100 completely enters the lower side of the target vehicle 10 when the ratio of the point cloud, which corresponds to the lower side of the target vehicle 10, to the entire point cloud, which excludes the ground surface, is the predetermined critical value or more.

When the processor 173 identifies that the first transport robot 100 completely enters the lower side of the target vehicle 10, the processor 173 may determine the positioning information based on the inertia data and the odometry data.

When the processor 173 identifies that the first transport robot 100 completely enters the lower side of the target vehicle 10, the processor 173 may perform control to turn off the lidar (non-entry lidar) that is the first lidar 134a or the second lidar 134b that is not identified as entering the lower side of the target vehicle 10.

In this case, the processor 173 may determine the positioning information of the first transport robot 100 by performing dead reckoning (DR) based on the inertia data and the odometry data.

Based on the positioning information of the first transport robot 100 determined by performing the dead reckoning based on the inertia data and the odometry data, the processor 173 may control the traveling device 110 so that the first transport robot 100 moves to a predesignated lower position of the target vehicle 10.

In this case, the predesignated lower position may be a position corresponding to the first position (or rear wheel position) of the target vehicle 10 or a position corresponding to a second position (or front wheel position). For example, in case that the first transport robot 100 is the leading transport robot, the predesignated lower position of the first transport robot 100 may be the position corresponding to the first position (or rear wheel position) of the target vehicle 10. In case that the first transport robot 100 is the trailing transport robot, the predesignated lower position of the first transport robot 100 may be the position corresponding to the second position (or front wheel position) of the target vehicle 10.

The second transport robot 200 may include a traveling device 210, a fork driving device 220, a sensing device 230, a lighting device 240, a communication part 250, and/or a controller 270.

The traveling device 210, the fork driving device 220, the sensing device 230, the lighting device 240, and the communication part 250 are not essential components of the second transport robot 200, and at least some of the above-mentioned components may be excluded.

The traveling device 210 may move and stop the second transport robot 200 and/or change a movement direction of the second transport robot 200.

The traveling device 210 may include a drive device 212, a braking device 214, and/or a steering device 216.

The drive device 212 may move the second transport robot 200. For example, the drive device 212 may include a motor (or also referred to as an ‘electric motor’) and rotate a wheel (or also referred to as an ‘electric wheel’) of the second transport robot 200 by providing driving power to the motor to move the second transport robot 200. For example, the wheel of the second transport robot 200 may be provided as a single wheel or a plurality of wheels and variously implemented in accordance with design.

The braking device 214 may stop a movement of the second transport robot 200. For example, the braking device 214 may include components such as a brake pad and a disc and stop the second transport robot 200.

The steering device 216 may change a movement direction of the second transport robot 200. For example, the steering device 216 may include components such as the motor or a hydraulic system for controlling a direction of the wheel of the second transport robot 200 and change the movement direction of the second transport robot 200.

The sensing device 230 may include one or more sensors capable of generating electrical signals or data corresponding to a state of the second transport robot 200 and/or an external state of the second transport robot 200.

The fork driving device 240 may include one or more motors or the like capable of providing driving power for motions of the plurality of forks f21, f22, f23, and f24 of the second transport robot 200.

With reference to FIG. 2, the second transport robot 200 may include the plurality of forks f21, f22, f23, and f24 having lengths extending from two opposite sides of the main body to support the two opposite wheels at the front side of the target vehicle 10.

For example, the forks f21, f22, f23, and f24 of the second transport robot 200 may each be implemented as a structure that may switch from a folded state to an unfolded state or switch from the unfolded state to the folded state on the basis that the fork driving device 240 is controlled by the controller 270.

In addition, the forks f21, f22, f23, and f24 of the second transport robot 200 may each be implemented as a structure that may ascend upward or descend downward in the unfolded state on the basis that the fork driving device 240 is controlled by the controller 270.

As another example, the forks f21, f22, f23, and f24 of the second transport robot 200 may each be implemented as a structure that may expand outward from the main body and change to a shape contracted toward the main body from the state expanding outward on the basis that the fork driving device 240 is controlled by the controller 270.

In addition, the forks f21, f22, f23, and f24 of the second transport robot 200 may each be implemented as a structure that may ascend upward or descend downward in the state expanding outward based on the main body on the basis that the fork driving device 240 is controlled by the controller 270.

The sensing device 230 may include a camera 232, a first lidar 234a, a second lidar 234b, an inertia measurement unit (IMU) 236, and/or an encoder 238.

The camera 232, the first lidar 234a, the second lidar 234b, the inertia measurement unit (IMU) 236, and/or the encoder 238 are not essential components of the sensing device 230, and at least some of the above-mentioned components may be excluded.

The camera 232 may acquire image data of the surrounding of the second transport robot 200. For example, the camera 232 may include a plurality of lenses (not illustrated), an image sensor, and/or an image processor (not illustrated).

The camera 232 may be provided as a single camera or a plurality of cameras and disposed on the main body of the second transport robot 200.

With reference to FIG. 1, the camera 232 may be disposed on the main body of the second transport robot 200 so as to have a visual field directed in the first direction (or also referred to as the ‘forward direction’) in which the second transport robot 200 moves.

With reference to FIG. 1, the first lidar 234a may be disposed on the main body of the second transport robot 200 so as to have a visual field in the first direction (or also referred to as the ‘forward direction’) in which the second transport robot 200 moves. The first lidar 234a may create first lidar data directed in the first direction (or forward direction).

The second lidar 234b may be disposed on the main body of the second transport robot 200 so as to have a visual field in the second direction (or also referred to as the ‘rearward direction’) that is the direction opposite to the first direction in which the second transport robot 200 moves. The second lidar 234b may create second lidar data directed in the second direction (or rearward direction).

The IMU 236 may acquire inertia data such as a velocity, a direction, and/or an acceleration of the second transport robot 200 and be disposed on the main body of the second transport robot 200.

With reference to FIG. 1, the IMU 236 may be disposed at a center of the main body of the second transport robot 200.

The encoder 238 may acquire odometry data such as a traveling distance of the second transport robot 200 and be installed in or adjacent to the wheel of the second transport robot 200.

The encoder 238 may be provided as a single encoder or a plurality of encoders.

The lighting device 240 may include one or more light sources or light source arrays and be disposed on the main body of the second transport robot 200. For example, various lighting devices (e.g., a light-emitting diode (LED), a halogen lamp, and the like) in the related art may be applied to the lighting device 240.

With reference to FIG. 1, markers, e.g., a first marker M3 and a second marker M4 may be disposed on the second transport robot 200. Although not illustrated, the lighting device 240 may be disposed on lower surfaces of the first and second markers M3 and M4 or disposed on the main body of the second transport robot 200 adjacent to the lower surfaces of the first and second markers M3 and M4 so that the visual fields toward the first marker M3 and the second marker M4 may be ensured.

For example, the first marker M3 and the second marker M4 may be manufactured to include a predetermined pattern, e.g., a pattern having four corner points.

The communication part 250 may establish a wireless communication channel between the second transport robot 200 and the first transport robot 100 and support communication performed through the established communication channel. The communication part 250 may include a communication circuit, and/or a control circuit capable of controlling an operation of the communication circuit. The communication part 250 may include a cellular communication module, a Wi-Fi communication module, a near-field communication module (e.g., a Bluetooth communication module), and/or a global navigation satellite system (GNSS) communication module and communicate with the first transport robot 100 through any one module.

The controller 270 may be electrically connected to and/or communicate with the constituent elements, e.g., the traveling device 210, the fork driving device 220, the sensing device 230, the lighting device 240, and/or the communication part 250 of the second transport robot 200 and control the constituent elements.

For example, the controller 270 may process the data acquired by the sensing device 230 and process the data received from the external device, e.g., the first transport robot 100 through the communication part 250. In addition, based on a result of processing the data acquired by the sensing device 230 and/or a result of processing the data received through the communication part 250, the controller 270 may provide control signal to the corresponding constituent elements among the traveling device 210, the fork driving device 220, the sensing device 230, the lighting device 240, and/or the communication part 250.

Based on the data acquired through the sensing device 230, e.g., the camera 232, the first lidar 234a, the second lidar 234b, the IMU 236, and/or the encoder 238, the controller 270 may acquire the positioning information of the second transport robot 200 and a relative posture with respect to one or more markers M1 and M2 installed on the first transport robot 100. For example, the relative position with respect to one or more markers M1 and M2 installed on the first transport robot 100 may include a relative posture with respect to the first transport robot 100.

The controller 270 may move the target vehicle 10 and park the target vehicle 10 in a designated parking zone through cooperative control with the first transport robot 100 through the communication part 250. In this case, the controller 270 may utilize the data acquired through the sensing device 230.

Based on the data acquired through the sensing device 230 and/or the data communication with the first transport robot 100 through the communication part 250, the controller 270 may control the drive device 212 included in the traveling device 210 and allow the second transport robot 200 to move to the lower side of the target vehicle 10.

The controller 270 may control the fork driving device 220 through the cooperative control with the first transport robot 100 through the communication part 250 so that the plurality of forks f21, f22, f23, and f24 may support the two opposite wheels at the front side of the vehicle 10, and then the plurality of forks f21, f22, f23, and f24 may ascend upward. In this case, the plurality of forks f11, f12, f13, and f14 of the first transport robot 100 may support the two opposite wheels at the rear side of the vehicle 10, and then the plurality of forks f11, f12, f13, and f14 may ascend upward.

In addition, in the state in which the plurality of forks f21, f22, f23, and f24 is raised upward, the controller 270 may move to the parking zone by controlling the drive device 212 included in the traveling device 210 while performing the cooperative control with the first transport robot 100 through the communication part 250. In this case, the first transport robot 100 may also move to the parking zone in the state in which the plurality of forks f11, f12, f13, and f14 is raised upward.

In addition, after the controller 270 moves to the parking zone, the controller 270 may perform control to lower the plurality of forks f21, f22, f23, and f24 and allow the plurality of forks f21, f22, f23, and f24 to release the two opposite wheels at the front side by performing the cooperative control with the first transport robot 100 through the communication part 250. In this case, the first transport robot 100 may also lower the plurality of forks f11, f12, f13, and f14, and the plurality of forks f11, f12, f13, and f14 may release the two opposite wheels at the rear side.

The controller 270 may include a memory 271 and/or a processor 273.

The memory 271 may store software programs for the second transport robot 200. The memory 271 may store programs and/or data for processing data (the data acquired through the sensing device 230 and/or the data received through the communication part 250).

The memory 271 may store a 3D map (or map information) of a parking lot (or parking location). The processor 273 may temporarily store the 3D map of a real-time surrounding environment created based on first and second lidar data acquired through the first and second lidars 234a and 234b.

The memory 271 may store identifiable predetermined patterns of markers of another transport robot including the markers M1 and M2 of the first transport robot 100.

The memory 271 may be temporarily memorize the data and temporarily memorize a result of processing the data of the processor 273.

The memory 271 may include not only volatile memories such as an S-RAM or a D-RAM, but also non-volatile memories such as a flash memory, a read-only memory (ROM) or an erasable programmable read-only memory (EPROM).

The processor 273 may process the data and provide the corresponding device with signals for controlling the traveling device 210, the fork driving device 220, the sensing device 230, the lighting device 240, and/or the communication part 250. For example, the processor 273 may include a micro control unit (MCU).

The processor 273 may control the fork drive device 220 so that the second transport robot 200 moves to the lower side of the target vehicle 10.

The processor 273 may determine the positioning information of the second transport robot 200 based on the map information of the parking location stored in the memory 271 and the first and second lidar data acquired through the first and second lidars 234a and 234b while the second transport robot 200 moves to the lower side of the target vehicle 10.

Specifically, the processor 273 may determine the positioning information by merging point clouds of the first and second lidar data and matching a feature point, which is extracted from the merged point cloud and the map information of the parking location.

The processor 273 may identify whether the first lidar 234a or the second lidar 234b enters the lower side of the target vehicle 10 based on the first and second lidar data.

That is, the processor 273 may determine the first lidar 234a or the second lidar 234b as a lidar (or entry lidar) identified as entering the lower side of the target vehicle 10.

To this end, based on the first lidar data, the processor 273 may determine the first lidar 234a as the lidar (entry lidar) identified as entering the lower side of the target vehicle 10 when a ratio of a point cloud, which corresponds to the lower side of the target vehicle 10, to the entire point cloud, which excludes a ground surface, is a predetermined critical value or more. When the first lidar 234a is determined as the entry lidar, the processor 273 may determine the second lidar 234b as a lidar (or non-entry lidar) that is not identified as entering the lower side of the target vehicle 10.

Based on the second lidar data, the processor 273 may determine the second lidar 234b as the lidar (or entry lidar) identified as entering the lower side of the target vehicle 10 when the ratio of the point cloud, which corresponds to the lower side of the target vehicle 10, to the entire point cloud, which excludes the ground surface, is the predetermined critical value or more. When the second lidar 234b is determined as the entry lidar, the processor 273 may determine the first lidar 234a as a lidar (or non-entry lidar) that is not identified as entering the lower side of the target vehicle 10.

In this case, the processor 273 may perform control to turn off the lidar (entry lidar) that is the first lidar 234a or the second lidar 234b that is identified as entering the lower side of the target vehicle 10.

Regardless of which lidar is determined as the entry lidar, the processor 273 may determine the positioning information based on the map information of the parking location and the lidar data of the lidar (non-entry lidar) that is not identified as entering the lower side of the target vehicle 10.

Next, based on the lidar data of the lidar (non-entry lidar) that is the first lidar 234a or the second lidar 234b that is not identified as entering the lower side of the target vehicle 10, the processor 273 may identify whether the second transport robot 200 completely enters the lower side of the target vehicle 10.

Based on the lidar data of the lidar (non-entry lidar) that is the first lidar 234a or the second lidar 234b that is not identified as entering the lower side of the target vehicle 10, the processor 273 may identify that the second transport robot 200 completely enters the lower side of the target vehicle 10 when the ratio of the point cloud, which corresponds to the lower side of the target vehicle 10, to the entire point cloud, which excludes the ground surface, is the predetermined critical value or more.

When the processor 273 identifies that the second transport robot 200 completely enters the lower side of the target vehicle 10, the processor 273 may determine the positioning information based on the inertia data and the odometry data. When the processor 273 identifies that the second transport robot 200 completely enters the lower side of the target vehicle 10, the processor 273 may perform control to turn off the lidar (non-entry lidar) that is the first lidar 234a or the second lidar 234b that is not identified as entering the lower side of the target vehicle 10.

In this case, the processor 273 may determine the positioning information of the second transport robot 200 by performing dead reckoning (DR) based on the inertia data and the odometry data.

Based on the positioning information of the second transport robot 200 determined by performing the dead reckoning based on the inertia data and the odometry data, the processor 273 may control the traveling device 210 so that the second transport robot 200 moves to a predesignated lower position of the target vehicle 10.

In this case, the predesignated lower position may be a position corresponding to the second position (or front wheel position) of the target vehicle 10 or a position corresponding to a first position (or rear wheel position). For example, in case that the second transport robot 200 is the leading transport robot, the predesignated lower position of the second transport robot 200 may be the position corresponding to the first position (or rear wheel position) of the target vehicle 10. In case that the second transport robot 200 is the trailing transport robot, the predesignated lower position of the second transport robot 200 may be the position corresponding to the second position (or front wheel position) of the target vehicle 10.

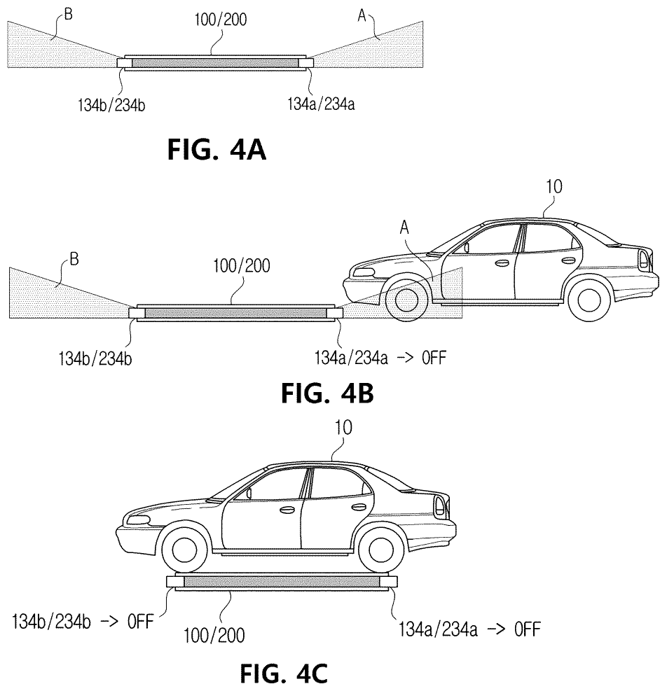

FIG. 4 is a view for explaining operations of the first transport robot and/or the second transport robot according to the embodiment.

With reference to FIG. 4A, the first transport robot 100 and/or the second transport robot 200 may begin to move to the target vehicle 10 that is an object to be parked.

In this case, the first transport robot 100 and/or the second transport robot 200 may identify positions thereof by determining the positioning information based on the first and second lidar data acquired through the first lidars 134a and 234a and the second lidars 134b and 234b and the map information of the parking location stored in advance in the memories 171 and 271.

For example, the first lidars 134a and 234a may be disposed on the main bodies of the first transport robot 100 and/or the second transport robot 200 so as to have the visual fields directed in the first direction (or also referred to as the ‘forward direction’) in which the first transport robot 100 and/or the second transport robot 200 move. In addition, the second lidars 134b and 234b may be disposed on the main bodies of the first transport robot 100 and/or the second transport robot 200 so as to have the visual fields directed in the second direction (or also referred to as the ‘rearward direction’) of the first transport robot 100 and/or the second transport robot 200. In addition, although not illustrated in FIG. 4, the IMUs 136 and 236 may be disposed in the main bodies of the first transport robot 100 and/or the second transport robot 200, and the encoders 138 and 238 may be disposed in or adjacent to the wheels of the first transport robot 100 and/or the second transport robot 200.

The first transport robot 100 and/or the second transport robot 200 may merge the point clouds of the first and second lidar data and extract the feature points from the merged point clouds while moving to the lower side of the target vehicle 10. The first transport robot 100 and/or the second transport robot 200 may determine the positioning information thereof by matching the map information and the feature points extracted from the merged point clouds.

With reference to FIG. 4B, the first transport robot 100 and/or the second transport robot 200 are covered by a vehicle body of the target vehicle 10 as the first transport robot 100 and/or the second transport robot 200 approach the lower side of the target vehicle 10. When the ratio of the point cloud, which corresponds to the lower side of the target vehicle 10, to the entire point cloud, which excludes the ground surface from the first lidar data of the first lidars 134a and 234a, is the predetermined critical value or more, the first transport robot 100 and/or the second transport robot 200 may determine the first lidars 134a and 234a as the lidars (entry lidars) that are the first lidars 134a and 234a or the second lidars 134b and 234b that are identified as entering the lower side of the target vehicle 10. Therefore, the first transport robot 100 and/or the second transport robot 200 may determine the second lidars 134b and 234b as the lidars (non-entry lidars) that are the first lidars 134a and 234a or the second lidars 134b and 234b that are not identified as entering the lower side of the target vehicle 10.

In this case, for example, the predetermined critical value may be 80%, 85%, 90%, 95%, or the like. That is, assuming that the entire point cloud, which excludes the ground surface from the first lidar data, is 100, for convenience, the ratio of the point cloud, which corresponds to the lower side of the target vehicle 10, to the entire point cloud, which excludes the ground surface, is 80% when the point cloud corresponding to the lower side of the target vehicle 10 is 80.

For example, when the predetermined critical value is 90% and the point cloud corresponding to the lower side of the target vehicle 10 is 80, the ratio of the point cloud, which corresponds to the lower side of the target vehicle 10, to the entire point cloud, which excludes the ground surface, is 80%. In this case, the first lidars 134a and 234a are not determined as the entry lidars because 80%, which is the ratio of the point cloud corresponding to the lower side of the target vehicle 10 to the entire point cloud excluding the ground surface from the first lidar data, is smaller than the predetermined critical value of 90%.

On the contrary, when the predetermined critical value is 90% and the point cloud corresponding to the lower side of the target vehicle 10 is 90, the ratio of the point cloud, which corresponds to the lower side of the target vehicle 10, to the entire point cloud, which excludes the ground surface, is 90%. In this case, the first lidars 134a and 234a are determined as the entry lidars because 90%, which is the ratio of the point cloud corresponding to the lower side of the target vehicle 10 to the entire point cloud excluding the ground surface from the first lidar data, is equal to the predetermined critical value of 90%.

For example, in the case of FIG. 4B, the first transport robot 100 and/or the second transport robot 200 determine the second lidars 134b and 234b as the lidars (non-entry lidars) that are not identified as entering the lower side of the target vehicle 10. The first transport robot 100 and/or the second transport robot 200 determine the positioning information based on the map information and the lidar data of the second lidars 134b and 234b that are the non-entry lidars.

In this case, the first transport robot 100 and/or the second transport robot 200 may turn off or deactivate the first lidars 134a and 234a that are the lidars (entry lidars) that are the first lidars 134a and 234a or the second lidars 134b and 234b that are identified as entering the lower side of the target vehicle 10.

With reference to FIG. 4C, the first transport robot 100 and/or the second transport robot 200 determine the positioning information based on the map information and the lidar data of the second lidars 134b and 234b while continuously moving to the predesignated lower position of the target vehicle 10. The first transport robot 100 and/or the second transport robot 200 identify whether the first transport robot 100 and/or the second transport robot 200 completely enter the lower side of the target object based on the lidar data of the second lidars 134b and 234b that are the non-entry lidar during this process. To this end, when the ratio of the point cloud, which corresponds to the lower side of the target vehicle 10, to the entire point cloud, which excludes the ground surface from the second lidar data of the second lidars 134b and 234b, is the predetermined critical value or more, the first transport robot 100 and/or the second transport robot 200 identify that the first transport robot 100 and/or the second transport robot 200 completely enter the lower side of the target vehicle 10.

In this case, for example, the predetermined critical value may be 80%, 85%, 90%, 95%, or the like. That is, assuming that the entire point cloud, which excludes the ground surface from the first lidar data, is 100, for convenience, the ratio of the point cloud, which corresponds to the lower side of the target vehicle 10, to the entire point cloud, which excludes the ground surface, is 80% when the point cloud corresponding to the lower side of the target vehicle 10 is 80.

For example, when the predetermined critical value is 90% and the point cloud corresponding to the lower side of the target vehicle 10 is 85, the ratio of the point cloud, which corresponds to the lower side of the target vehicle 10, to the entire point cloud, which excludes the ground surface, is 85%. In this case, the lidar is not identified as completely entering the lower side of the target vehicle 10 because 85%, which is the ratio of the point cloud corresponding to the lower side of the target vehicle 10 to the entire point cloud excluding the ground surface from the second lidar data, is smaller than the predetermined critical value of 90%.

On the contrary, when the predetermined critical value is 90% and the point cloud corresponding to the lower side of the target vehicle 10 is 92, the ratio of the point cloud, which corresponds to the lower side of the target vehicle 10, to the entire point cloud, which excludes the ground surface, is 92%. In this case, the lidar is identified as completely entering the lower side of the target vehicle 10 because 92%, which is the ratio of the point cloud corresponding to the lower side of the target vehicle 10 to the entire point cloud excluding the ground surface from the second lidar data, is larger than the predetermined critical value of 90%.

In this case, the first transport robot 100 and/or the second transport robot 200 may turn off or deactivate the second lidars 134b and 234b that are the lidars (non-entry lidars) that are not identified as entering the lower side of the target vehicle 10.

Therefore, the first transport robot 100 and/or the second transport robot 200 may determine the positioning information of the first transport robot 100 and/or the second transport robot 200 based on the inertia data acquired through the IMUs 136 and 236 and the odometry data acquired through the encoders 138 and 238. Specifically, the first transport robot 100 and/or the second transport robot 200 may determine the positioning information by performing the dead reckoning based on the inertia data and the odometry data.

The first transport robot 100 and/or the second transport robot 200 may move to the predesignated lower position of the target vehicle 10 based on the positioning information determined based on the inertia data and the odometry data.

In this case, the predesignated lower position may be a position corresponding to the second position (or front wheel position) of the target vehicle 10 or a position corresponding to a first position (or rear wheel position).

For example, in case that the first transport robot 100 is the leading transport robot, the predesignated lower position of the first transport robot 100 may be the position corresponding to the first position (or rear wheel position) of the target vehicle 10. In this case, the second transport robot 200 may be the trailing transport robot, and the predesignated lower position of the second transport robot 200 may be the position corresponding to the second position (or front wheel position) of the target vehicle 10.

On the contrary, for example, in case that the second transport robot 200 is the leading transport robot, the predesignated lower position of the second transport robot 200 may be the position corresponding to the first position (or rear wheel position) of the target vehicle 10. In this case, the first transport robot 100 may be the trailing transport robot, and the predesignated lower position of the first transport robot 100 may be the position corresponding to the second position (or front wheel position) of the target vehicle 10.

Meanwhile, the first transport robot 100 and/or the second transport robot 200 may turn on or activate the first lidars 134a and 234a when the first transport robot 100 and/or the second transport robot 200 completely move to the predesignated lower position of the target vehicle 10 based on the positioning information determined based on the inertia data and the odometry data. When a ratio of the point cloud, which corresponds to the lower side of the target vehicle 10, to the entire point cloud, which excludes the ground surface from the first lidar data acquired from the first lidars 134a and 234a turned on or activated again, is less than the predetermined critical value, the first transport robot 100 and/or the second transport robot 200 determine the positioning information based on the first lidar data and the map information.

For example, when the predetermined critical value is 90% and the point cloud corresponding to the lower side of the target vehicle 10 is 80, the ratio of the point cloud, which corresponds to the lower side of the target vehicle 10, to the entire point cloud, which excludes the ground surface, is 80%. In this case, because 80%, which is the ratio of the point cloud corresponding to the lower side of the target vehicle 10 to the entire point cloud excluding the ground surface from the first lidar data, is less than the predetermined critical value of 90%, the first transport robot 100 and/or the second transport robot 200 determine the positioning information based on the first lidar data and the map information.

As described above, when the first transport robot 100 and/or the second transport robot 200 completely move to the predesignated lower position of the target vehicle 10, the first transport robot 100 and/or the second transport robot 200 may turn on or activate the first lidars 134a and 234a. The first transport robot 100 and/or the second transport robot 200 may determine the positioning information based on the first lidar data and the map information in response to the situation in which the ratio of the point cloud corresponding to the lower side of the target vehicle 10 to the entire point cloud excluding the ground surface from the first lidar data is less than the predetermined critical value.

However, the present disclosure is not limited thereto. In case that the ratio of the point cloud corresponding to the lower side of the target vehicle 10 to the entire point cloud excluding the ground surface from the first lidar data is less than the predetermined critical value, and for example, the ratio is a predetermined additional critical value or more, the first transport robot 100 and/or the second transport robot 200 may determine the positioning information by fusing the first lidar data and the map information with the dead reckoning based on the inertia data and the odometry data.

This is because the ratio of the point cloud corresponding to the lower side of the target vehicle 10 to the entire point cloud excluding the ground surface from the first lidar data may vary depending on the type of target vehicle 10, and the reliability may be considered insufficient to determine the positioning information only based on the first lidar data even though the ratio is less than the predetermined critical value.

For example, when the predetermined critical value is 90% and the point cloud corresponding to the lower side of the target vehicle 10 is 81 when the predetermined additional critical value is 80%, the ratio of the point cloud, which corresponds to the lower side of the target vehicle 10, to the entire point cloud, which excludes the ground surface, is 81%. In this case, because 80%, which is the ratio of the point cloud corresponding to the lower side of the target vehicle 10 to the entire point cloud excluding the ground surface from the first lidar data, is less than the predetermined critical value of 90% and larger than the predetermined additional critical value of 80%, the first transport robot 100 and/or the second transport robot 200 may determine the positioning information by fusing the first lidar data and the map information with the dead reckoning based on the inertia data and the odometry data.

On the contrary, in case that the ratio of the point cloud corresponding to the lower side of the target vehicle 10 to the entire point cloud excluding the ground surface from the first lidar data is less than the predetermined critical value, and for example, the ratio is less than the predetermined additional critical value, the first transport robot 100 and/or the second based on the first lidar data and the map information.

For example, when the predetermined critical value is 90% and the point cloud corresponding to the lower side of the target vehicle 10 is 79 when the predetermined additional critical value is 80%, the ratio of the point cloud, which corresponds to the lower side of the target vehicle 10, to the entire point cloud, which excludes the ground surface, is 79%. In this case, because 79%, which is the ratio of the point cloud corresponding to the lower side of the target vehicle 10 to the entire point cloud excluding the ground surface from the first lidar data, is less than the predetermined critical value of 90% and less than the predetermined additional critical value of 80%, the first transport robot 100 and/or the second transport robot 200 may determine the positioning information based on the first lidar data and the map information.

Because the technology (e.g., a lidar map matching technology, a sensor fusion technology, the dead reckoning, and the like) for identifying the position of the target object and the position of the object having the camera, the first lidar, the second lidar, the IMU, and/or the encoder based on the data acquired through the camera, the first lidar, the second lidar, the IMU, and/or the encoder are publicly-known technologies in the related art, detailed descriptions thereof will be omitted.

The second transport robot 200 may identify the one or more markers M1 and M2 installed on the first transport robot 100 based on the image data acquired through the camera 232.

For example, the second transport robot 200 may identify the first and second markers M1 and M2 of the first transport robot 100 included in the image data acquired through the camera 232 and identify the relative posture with respect to the first transport robot 100 based on the first and second markers M1 and M2.

For example, the second transport robot 200 may identify the relative postures of the first and second markers M1 and M2 with respect to the second transport robot 200 by identifying the patterns included in the first and second markers M1 and M2.

That is, in case that the second transport robot 200 identifies the one or more markers M1 and M2 installed on the first transport robot 100, the positioning information of the second transport robot 200 may be corrected based on the relative postures of the one or more markers M1 and M2 with respect to the second transport robot 200.

In this case, the relative postures may include relative positions between the second transport robot 200 and the one or more markers M1 and M2.

The first transport robot 100 and the second transport robot 200 may move simultaneously.

For example, the first transport robot 100 may identify a distance from the second transport robot 200 while the second transport robot 200 moves. In case that the distance from the second transport robot 200 is a predesignated spacing distance, the first transport robot 100 may begin to move and move together with the second transport robot 200.

For example, the first transport robot 100 may determine the distance from the second transport robot 200 based on the positioning information received from the second transport robot 200. In case that the distance from the second transport robot 200 is the predesignated spacing distance, the first transport robot 100 may begin to move and move together with the second transport robot 200.

In addition, the second transport robot 200 may determine a distance from the first transport robot 100 based on image data acquired through the camera 232. In case that the distance from the first transport robot 100 is a predesignated spacing distance, the second transport robot 200 may begin to move and move together with the first transport robot 100. For example, the second transport robot 200 may determine the distance from the first transport robot 100 by identifying the first and second markers M1 and M2 of the first transport robot 100 included in the image data.

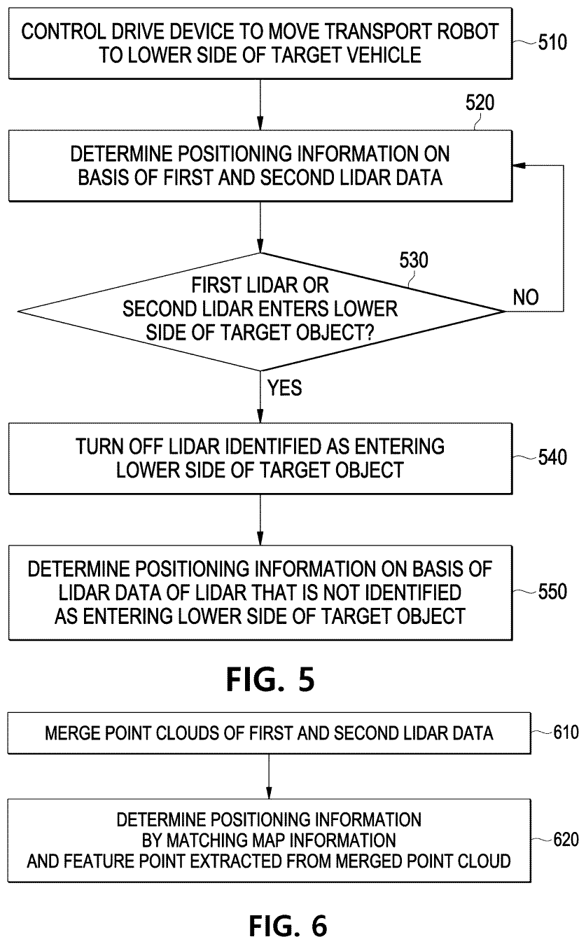

FIG. 5 is a flowchart illustrating an operation from a time point at which the first transport robot and/or the second transport robot according to the embodiment begin to move to the target object to a time point at which the first transport robot and/or the second transport robot are identified as entering the lower side of the target object.

With reference to FIG. 5, the first transport robot 100 and/or the second transport robot 200 may control the drive devices 112 and 212 so that the first transport robot 100 and/or the second transport robot 200 move to the lower side of the target vehicle 10 (510).

The first transport robot 100 and/or the second transport robot 200 may determine the positioning information of the first transport robot 100 and/or the second transport robot 200 based on the map information and the first and second lidar data acquired through the first and second lidars 134a and 134b (520).

The first transport robot 100 and/or the second transport robot 200 may identify whether the first lidars 134a and 234a or the second lidars 134b and 234b enter the lower side of the target vehicle 10 based on the first and second lidar data (530).

The first transport robot 100 and/or the second transport robot 200 may determine the lidars that are the first lidars 134a and 234a or the second lidars 134b and 234b, which are identified as entering the lower side of the target vehicle 10, as the entry lidars (540).

In this case, the first transport robot 100 and/or the second transport robot 200 may perform control to turn off the lidars (entry lidars) that are the first lidars 134a and 234a or the second lidars 134b and 234b that are identified as entering the lower side of the target vehicle 10 (550).

Next, the first transport robot 100 and/or the second transport robot 200 may determine the lidars (non-entry lidars) that are the first lidars 134a and 234a or the second lidars 134b and 234b that are not identified as entering the lower side of the target vehicle 10 (560).

For example, when the first lidars 134a and 234a are determined as the entry lidars, the first transport robot 100 and/or the second transport robot 200 may determine the second lidars 134b and 234b as the lidars (non-entry lidars) that are not identified as entering the lower side of the target vehicle 10. If the second lidars 134b and 234b are determined as the entry lidars, the first transport robot 100 and/or the second transport robot 200 may determine the first lidars 134a and 234a as the lidars (non-entry lidars) that are not identified as entering the lower side of the target vehicle 10.

The first transport robot 100 and/or the second based on the map information of the parking location and the lidar data of the lidar (non-entry lidar) that is not identified as entering the lower side of the target vehicle 10 (570).

FIG. 6 is a flowchart illustrating an operation of determining positioning information before the first transport robot and/or the second transport robot according to the embodiment are identified as entering the lower side of the target object.

The first transport robot 100 and/or the second transport robot 200 may merge the point clouds of the first lidar data acquired from the first lidars 134a and 234a and the second lidar data acquired from the second lidars 134b and 234b (610).

The first transport robot 100 and/or the second transport robot 200 may determine the positioning information by matching the map information of the parking location and the feature points extended from the merged point cloud (620).

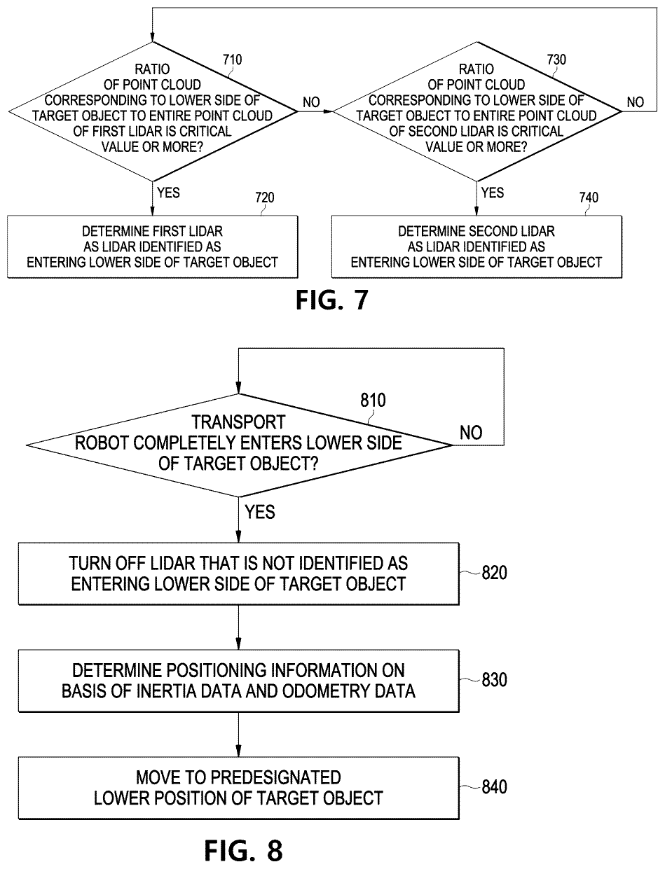

FIG. 7 is a flowchart illustrating an operation of identifying whether the first lidar or the second lidar of the first transport robot and/or the second transport robot according to the embodiment enter the lower side of the target object.

With reference to FIG. 7, based on the first lidar data, the first transport robot 100 and/or the second transport robot 200 may determine whether the ratio of the point cloud, which corresponds to the lower side of the target vehicle 10, to the entire point cloud, which excludes the ground surface, is the predetermined critical value or more (710).

When the ratio of the point cloud, which corresponds to the lower side of the target vehicle 10, to the entire point cloud, which excludes the ground surface from the first lidar data, is the predetermined critical value or more, the first transport robot 100 and/or the second transport robot 200 may determine the first lidars 134a and 234a as the lidars (entry lidars) that are identified as entering the lower side of the target vehicle 10 (720).

When the ratio of the point cloud, which corresponds to the lower side of the target vehicle 10, to the entire point cloud, which excludes the ground surface, is less than the predetermined critical value, the first transport robot 100 and/or the second transport robot 200 may determine, based on the second lidar data, whether the ratio of the point cloud, which corresponds to the lower side of the target vehicle 10, to the entire point cloud, which excludes the ground surface, is the predetermined critical value or more (730).

When the ratio of the point cloud, which corresponds to the lower side of the target vehicle 10, to the entire point cloud, which excludes the ground surface from the second lidar data, is the predetermined critical value or more, the first transport robot 100 and/or the second transport robot 200 may determine the second lidars 134b and 234b as the lidars (entry lidars) that are identified as entering the lower side of the target vehicle 10 (740).

FIG. 8 is a flowchart illustrating an operation of determining positioning information while the first transport robot and/or the second transport robot according to the embodiment move to a predesignated lower position of the target object from a time point at which the first transport robot and/or the second transport robot completely enter the lower side of the target object.

It is noted that in the order of time or method, FIG. 8 illustrates a series of processes continued from the determining (570) of the positioning information based on the map information of the parking location and the lidar data of the lidar (non-entry lidar) in FIG. 5 that is not identified as entering the lower side of the target vehicle 10.

With reference to FIG. 8, the first transport robot 100 and/or the second transport robot 200 may identify whether the first transport robot 100 and/or the second transport robot 200 completely enter the lower side of the target vehicle 10 based on the lidar data of the lidar (non-entry lidar) that is not identified as entering the lower side of the target vehicle 10 (810).

When the first transport robot 100 and/or the second transport robot 200 are identified as completely entering the lower side of the target vehicle 10, the first transport robot 100 and/or the second transport robot 200 may perform control to turn off the lidar (non-entry lidar) that is not identified as entering the lower side of the target vehicle 10 (820).

The first transport robot 100 and/or the second transport robot 200 may determine the positioning information of the first transport robot 100 and/or the second transport robot 200 by performing the dead reckoning (DR) based on the inertia data and the odometry data (830).

Lastly, the first transport robot 100 and/or the second transport robot 200 may move to the predesignated lower position of the target vehicle 10 based on the positioning information of the first transport robot 100 and/or the second transport robot 200 determined by performing the dead reckoning based on the inertia data and the odometry data (840).

In this case, the predesignated lower position may be the position corresponding to the second position (or front wheel position) of the target vehicle 10 or the position corresponding to the first position (or rear wheel position).

For example, in case that the first transport robot 100 is the leading transport robot, the predesignated lower position of the first transport robot 100 may be the position corresponding to the first position (or rear wheel position) of the target vehicle 10. In this case, the second transport robot 200 may be the trailing transport robot, and the predesignated lower position of the second transport robot 200 may be the position corresponding to the second position (or front wheel position) of the target vehicle 10.

On the contrary, for example, in case that the second transport robot 200 is the leading transport robot, the predesignated lower position of the second transport robot 200 may be the position corresponding to the first position (or rear wheel position) of the target vehicle 10. In this case, the first transport robot 100 may be the trailing transport robot, and the predesignated lower position of the first transport robot 100 may be the position corresponding to the second position (or front wheel position) of the target vehicle 10.

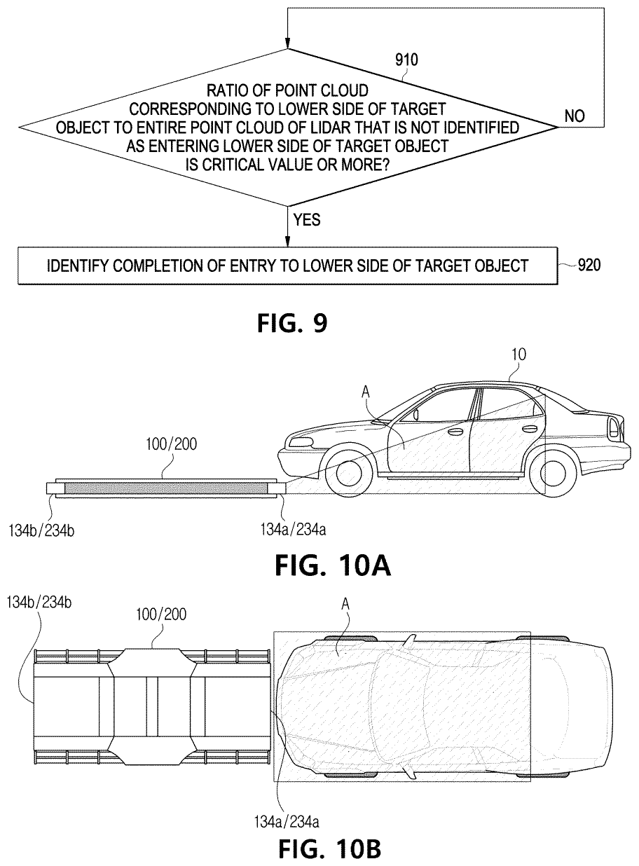

FIG. 9 is a flowchart illustrating an operation of identifying that the first transport robot and/or the second transport robot according to the embodiment completely enter the lower side of the target object.

With reference to FIG. 9, the first transport robot 100 and/or the second transport robot 200 may determine whether the ratio of the point cloud, which corresponds to the lower side of the target vehicle 10, to the entire point cloud, which excludes the ground surface from the lidar data of the lidar (non-entry lidar) that is not identified as entering the lower side of the target vehicle 10, is the predetermined critical value or more (910).

When the ratio of the point cloud, which corresponds to the lower side of the target vehicle 10, to the entire point cloud, which excludes the ground surface from the lidar data of the lidar (non-entry lidar) that is not identified as entering the lower side of the target vehicle 10, is the predetermined critical value or more, the first transport robot 100 and/or the second transport robot 200 may identify that the first transport robot 100 and/or the second transport robot 200 completely enter the lower side of the target vehicle 10 (920).

FIG. 10 is a view exemplarily illustrating an ROI (region of interest) for identifying that the first transport robot and/or the second transport robot according to the embodiment enter the lower side of the target object.

With reference to FIG. 10, a ratio of a point cloud (ROI), which corresponds to the lower side of the target vehicle 10, to the entire point cloud, which excludes the ground surface of the first lidars 134a and 234a of the first transport robot 100 and/or the second transport robot 200 may be 100% or significantly adjacent to 100%.

In this case, the ratio of the point cloud (ROI), which corresponds to the lower side of the target vehicle 10, to the entire point cloud, which excludes the ground surface of the first lidars 134a and 234a of the first transport robot 100 and/or the second transport robot 200, may be mostly the predetermined critical value or more. Therefore, in this case, the first transport robot 100 and/or the second transport robot 200 may determine the first lidars 134a and 234a as the lidar (entry lidar) that is identified as entering the lower side of the target vehicle 10.

Meanwhile, in case that the first transport robot 100 is the leading transport robot and the second transport robot 200 is the trailing transport robot, the second transport robot 200 may transfer the positioning information of the second transport robot 200 to the first transport robot 100 through the communication part 250 while the second transport robot 200 moves to the lower side of the target vehicle 10 along the first transport robot 100.

For example, the second transport robot 200 may receive, through the communication part 250, signals indicating the completion of the movement from the first transport robot 100 to the predesignated lower position, e.g., the position corresponding to the first position (or rear wheel position) of the target vehicle 10 and/or indicating the switching of the standby state in accordance with the completion of the movement. In response to this situation, the positioning information of the second transport robot 200 may be acquired, and the second transport robot 200 may begin to move toward the target vehicle 10.

The second transport robot 200 may move to the predesignated lower position, e.g., the position corresponding to the second position (or front wheel position) of the target vehicle 10.

As described above, the predesignated lower position of the first transport robot 100 and the predesignated lower position of the second transport robot 200 are always set to be different from each other.

In case that the first transport robot 100 and the second transport robot 200 are respectively positioned at the predesignated lower positions of the target vehicle 10, the first transport robot 100 and the second transport robot 200 may perform the cooperative control to move the target vehicle 10 to the predesignated parking point and park the target vehicle 10.

In the above-mentioned embodiments, the positions of the camera 132, the first lidar 134a, and the second lidar 134b of the first transport robot 100 have been described exemplarily. The camera 132, the first lidar 134a, and the second lidar 134b may be installed at various positions on the first transport robot 100. The number of cameras 132, the number of first lidars 134a, and the number of second lidars 134b of the first transport robot 100 may also be variously applied.

In addition, in the above-mentioned embodiments, the positions of the camera 232, the first lidar 234a, and the second lidar 234b of the second transport robot 200 have been described exemplarily. The camera 232, the first lidar 234a, and the second lidar 234b may be installed at various positions on the second transport robot 200. The number of cameras 232, the number of first lidars 234a, and the number of second lidars 234b of the second transport robot 200 may also be variously applied.

In addition, in the above-mentioned embodiment, the number of markers and the positions of the markers have been described exemplarily. The number of markers and the positions of the markers may be variously changed in accordance with design of the designer.

In addition, in the above-mentioned embodiments, the fork has been described exemplarily. The forks with various shapes and various numbers may be implemented to support the wheels of the target vehicle 10 and raise and lower the wheels of the target vehicle 10 in accordance with design of the designer.

According to the embodiment of the disclosed disclosure, it is possible to provide the transport robot, which is capable of acquiring highly reliable positioning information by expanding the visual field (field of view) of the lidar by merging the point clouds created by the first lidar and the second lidar, and the method of controlling the same.

According to the embodiment of the disclosed disclosure, it is possible to provide the transport robot, which is capable of acquiring precise positioning information by changing the configurations of the sensors utilized to determine the positioning information in a stepwise manner during the process in which the transport robot enters the lower side of the target object, and the method of controlling the same.

On the other hand, the disclosed embodiments may be implemented in the form of a recording medium that stores computer-executable instructions. The instruction may be stored in the form of a program code. When the instruction is executed by a processor, a program module may be generated, and operations of the disclosed embodiments may be performed. The recording medium may be implemented as a computer-readable recording medium.

Examples of the computer-readable recording medium include all kinds of recording media for storing instructions readable by a computer. Specific examples thereof may include a read only memory (ROM), a random access memory (RAM), a magnetic tape, a magnetic disc, a flash memory, an optical data storage device, and the like.

The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. For example, a “non-transitory storage medium” may include a buffer that temporarily stores data.

As described above, the embodiments have been described with reference to the accompanying drawings. A person skilled in the art may understand that the present disclosure may be carried out in other forms different from those disclosed in the embodiments without changing the technical spirit or the essential features of the present disclosure. The disclosed embodiments are illustrative and should not be interpreted as being restrictive.

What is claimed is:

1. A transport robot comprising:
a drive device configured to move the transport robot;
a first lidar installed on the transport robot and configured to acquire first lidar data directed in a first direction;
a second lidar installed on the transport robot and configured to acquire second lidar data directed in a second direction; and
a processor configured to control the drive device to move the transport robot to a lower side of a target object and determine positioning information of the transport robot based on the first lidar data and the second lidar data while the transport robot moves to the lower side of the target object,
wherein the processor identifies whether the first lidar or the second lidar enters the lower side of the target object based on the first lidar data and the second lidar data, and
wherein when the first lidar or the second lidar is identified as entering the lower side of the target object, the processor determines the positioning information based on lidar data of a lidar that is the first lidar or the second lidar that is not identified as entering the lower side of the target object.

2. The transport robot of claim 1, wherein the processor merges point clouds of the first lidar data and the second lidar data and determines the positioning information by matching pre-stored map information and a feature point extracted from the merged point cloud, and
wherein when the first lidar or the second lidar is identified as entering the lower side of the target object, the processor determines the positioning information by matching the pre-stored map information and the feature point extracted from the point cloud of the lidar data of the lidar that is the first lidar or the second lidar that is not identified as entering the lower side of the target object.

3. The transport robot of claim 1, wherein the processor determines, based on the first lidar data, the first lidar as the lidar identified as entering the lower side of the target object when a ratio of a point cloud, which corresponds to the lower side of the target object, to the entire point cloud, which excludes a ground surface, is a predetermined critical value or more, and
wherein the processor determines, based on the second lidar data, the second lidar as the lidar identified as entering the lower side of the target object when the ratio of the point cloud, which corresponds to the lower side of the target object, to the entire point cloud, which excludes the ground surface, is the predetermined critical value or more.

4. The transport robot of claim 1, wherein the processor performs control to turn off the lidar that is the first lidar or the second lidar that is identified as entering the lower side of the target object.

5. The transport robot of claim 1, further comprising:
an inertia measurement unit installed on the transport robot and configured to acquire inertia data; and
an encoder installed on the transport robot and configured to acquire odometry data,
wherein the processor identifies whether the transport robot completely enters the lower side of the target object based on the lidar data of the lidar that is the first lidar or the second lidar that is not identified as entering the lower side of the target object, and
wherein the processor determines the positioning information based on the inertia data and the odometry data when the transport robot is identified as completely entering the lower side of the target object.

6. The transport robot of claim 5, wherein the processor determines the positioning information by performing dead reckoning based on the inertia data and the odometry data.

7. The transport robot of claim 5, wherein the processor identifies that the transport robot completely enters the lower side of the target object when a ratio of a point cloud, which corresponds to the lower side of the target object, to the entire point cloud, which excludes a ground surface, is a predetermined critical value or more based on the lidar data of the lidar that is the first lidar or the second lidar that is not identified as entering the lower side of the target object.

8. The transport robot of claim 5, wherein the processor controls the drive device so that the transport robot moves to a predesignated lower position of the target object based on the positioning information.

9. The transport robot of claim 5, wherein the processor performs control to turn off the lidar that is the first lidar or the second lidar that is not identified as entering the lower side of the target object when the transport robot is identified as completely entering the lower side of the target object.

10. The transport robot of claim 8, wherein the predesignated lower position of the target object is a position corresponding to any one of first and second positions of the target object.

11. A method of controlling a transport robot comprising a drive device and a processor, the method comprising:
controlling the drive device so that the transport robot moves to a lower side of a target object;
determining positioning information of the transport robot based on first lidar data directed in a first direction and acquired by a first lidar and second lidar data directed in a second direction and acquired by a second lidar while the drive device is controlled;
identifying whether the first lidar or the second lidar enters the lower side of the target object based on the first lidar data and the second lidar data; and
determining the positioning information based on lidar data of a lidar that is the first lidar or the second lidar that is not identified as entering the lower side of the target object when the first lidar or the second lidar is identified as entering the lower side of the target object.

12. The method of claim 11, wherein the determining of the positioning information of the transport robot based on the first lidar data and the second lidar data comprises:
merging point clouds of the first lidar data and the second lidar data; and
determining the positioning information by matching pre-stored map information and a feature point extracted from the merged point cloud, and
wherein the determining of the positioning information based on the lidar data of the lidar that is not identified as entering the lower side of the target object comprises determining the positioning information by matching the pre-stored map information and the feature point extracted from the point cloud of the lidar data of the lidar that is the first lidar or the second lidar that is not identified as entering the lower side of the target object.

13. The method of claim 11, wherein the identifying of whether the first lidar or the second lidar enters the lower side of the target object comprises:
determining, based on the first lidar data, the first lidar as the lidar identified as entering the lower side of the target object when a ratio of a point cloud, which corresponds to the lower side of the target object, to the entire point cloud, which excludes a ground surface, is a predetermined critical value or more; and
determining, based on the second lidar data, the second lidar as the lidar identified as entering the lower side of the target object when the ratio of the point cloud, which corresponds to the lower side of the target object, to the entire point cloud, which excludes the ground surface, is the predetermined critical value or more.

14. The method of claim 11, further comprising:
turning off the lidar that is the first lidar or the second lidar that is identified as entering the lower side of the target object.

15. The method of claim 11, further comprising:
identifying whether the transport robot completely enters the lower side of the target object based on the lidar data of the lidar that is the first lidar or the second lidar that is not identified as entering the lower side of the target object; and
determining the positioning information based on inertia data acquired by an inertia measurement unit and odometry data acquired by an encoder when the transport robot is identified as completely entering the lower side of the target object.

16. The method of claim 15, wherein the determining of the positioning information based on the inertia data and the odometry data comprises determining the positioning information by performing dead reckoning based on the inertia data and the odometry data.

17. The method of claim 15, wherein the identifying of whether the transport robot completely enters the lower side of the target object comprises identifying that the transport robot completely enters the lower side of the target object when a ratio of a point cloud, which corresponds to the lower side of the target object, to the entire point cloud, which excludes a ground surface, is a predetermined critical value or more based on the lidar data of the lidar that is the first lidar or the second lidar that is not identified as entering the lower side of the target object.

18. The method of claim 15, further comprising:
controlling the drive device so that the transport robot moves to a predesignated lower position of the target object based on the positioning information.

19. The method of claim 15, further comprising:
turning off the lidar that is the first lidar or the second lidar that is not identified as entering the lower side of the target object when the transport robot is identified as entering the lower side of the target object.

20. The method of claim 18, wherein the predesignated lower position of the target object is a position corresponding to any one of first and second positions of the target object.
